(19) United States
(12) Patent Application Publication
(10) Pub. No.: US 2022/0250366 A1
(43) Pub. Date: Aug. 11, 2022

(54) SEALABLE EXTRUSION COATING WITH IMPROVED PROCESSING AND PROPERTIES

(71) Applicant: WestRock MWV, LLC, Atlanta, GA (US)

(72) Inventors: Rahul BHARDWAJ, Glen Allen, VA (US); Chitai C. YANG, Mechanicsville, VA (US); Chester E. ALKIEWICZ, Glen Allen, VA (US); Matthew S. CAMERON, Covington, VA (US)

(21) Appl. No.: 17/629,390

(22) PCT Filed: Jun. 29, 2020
(86) PCT No.: PCT/US2020/040082

§ 371 Date: Jan. 23, 2022

Related U.S. Application Data
(60) Provisional application No. 62/877,387, filed on Jul. 23, 2019.

(51) Int. Cl. B32B 27/10; B32B 27/08; B32B 27/30; B32B 27/36

(52) U.S. Cl. CPC B32B 27/10; B32B 27/08; B32B 27/308; B32B 27/36; B32B 27/16; B32B 2307/31; B32B 2307/718; B32B 2439/80; B32B 2255/12

(57) ABSTRACT

A laminate structure including a paperboard substrate and a sealable layer that forms a laminate outer surface. The sealable layer may include a blend of modified ethylene methyl acrylate and one or more polyethylenes.

### PRIORITY

This application claims priority from U.S. Ser. No. 62/877,387 filed on Jul. 23, 2019, the entire contents of which are incorporated herein by reference.

### FIELD

This application relates to paperboard structures and, more particularly, a laminated paperboard structure that may be sealed to form packaging structures using heat or other forms of energy.

### BACKGROUND

Use of heat sealable paperboard materials for packaging is described, for example, in U.S. Pat. No. 5,091,261 (Casey et al.). This patent describes a laminate for packaging applications comprised of a paperboard substrate having one coated, printable surface (C1S), and having adhered to the opposing side a co-extrudate of low-density polyethylene and an adhesive material, for example, ethylene methyl-acrylate copolymer. This adhesive material enables the laminate to be used for applications such as the manufacture of blister cards, which requires that a tight seal be formed between the laminate and the plastic material of the blister. In this regard, the adhesive material is a heat sealable component that plasticizes at low heat, so that when opposing surfaces treated with the same material are contacted, the adhesive material bonds together to form a seal.

U.S. Pat. No. 6,010,784 relates to a paperboard laminate, where an ethylene-vinyl acetate (EVA) based hot melt forms the sealant layer, for pharmaceutical blister packaging. The hot melt layer seals to common blister forming films including polychlorotrifluoroethylene (Aclar®), a high barrier film.

The packaging laminates described in U.S. Pat. Nos. 5,091,261 and 6,010,784 exhibit the additional advantage of being clay-coated and thus printable on one side. Accordingly, they are suited to consumer packaging applications, for example, for packaging of unit dose pharmaceuticals. However, these materials lack high tear resistance and burst resistance, which are both characteristics desired for various packaging applications including but not limited to pharmaceutical packaging.

A tear resistant heat sealable paperboard is disclosed in commonly assigned U.S. Pat. No. 7,144,635 issued on Dec. 5, 2006 and commonly owned by the Applicant.

While such packaging material with heat sealing ability is particularly well suited to secure packaging of consumable goods, the sealable material may sometimes exhibit unwanted characteristics. When rolls of such paperboard are stored for long periods of time, the layers may “block” (stick together), even to the extent that entire rolls may be useless. Also, the constituents of the sealable material may transfer to the printable surface, causing mottling or other print defects.

One effort to address these characteristics is described in U.S. Published Patent Application 2018/0257349 A1, published Sep. 13, 2018 and commonly owned by the Applicant. A multi-layer laminate structure is disclosed in which the outermost sealable layer includes a blend of modified ethylene methyl acrylate (EMA) and an EMA copolymer. Disposed immediately beneath the sealable layer is a layer of polymer such as low-density polyethylene (LDPE) or EMA used as an adhesive to secure the sealable layer to a tear-resistant layer.

While the structure described in U.S. Published Patent Application 2018/0257349 A1 shows improved results over prior art structures with respect to blocking and material transfer, it must be processed at a relatively high temperature and is manufactured using a co-extrusion process which presents issues such as edge encapsulation. It is desired therefore to have a sealable packaging material that overcomes these disadvantages and does not exhibit blocking or print-side degradation. These objectives are met by the various embodiments of the packaging material described and claimed herein.

### SUMMARY

In one aspect a laminate structure is disclosed that includes a paperboard substrate having a first side and a second side opposed from the first side, and a sealable layer forming the laminate outer surface on the second side, wherein the sealable layer comprises a blend of (by weight) from 5 to 95% of modified EMA, and 5 to 95% of one or more polyethylenes selected from the group comprising homopolymers, copolymers, terpolymers, functionalized polymers, low-density polyethylene (LDPE), high-density polyethylene (HDPE), and medium-density polyethylene.

In another aspect, a method of manufacturing a laminate structure is disclosed including pressing together a paperboard substrate, a laminating layer and a PET film in a nip between pressure roll and chill roll at a first extrusion coater, wherein a curtain of the laminating layer is positioned between paperboard substrate and a film of PET. Then pressing together a curtain of plastic onto a surface of the PET-coated paperboard substrate in a nip between a pressure roll and a chill roll at a second extrusion coater.

Other aspects of the disclosed laminate structure will become apparent from the following detailed description, the accompanying drawings, and the appended claims.

### BRIEF DESCRIPTION OF THE DRAWINGS

FIG. 1A is a schematic representation of a cross section of a sealable laminate;

FIG. 1B is a simplified diagram of a process for making a sealable laminate;

FIG. 2 is a perspective view of an extrusion coating process;

FIG. 3 is a front view of an extruded coating being applied to paperboard;

FIG. 4 is a schematic representation of a cross section of a sealable laminate according to an embodiment of the invention;

FIG. 5 is a schematic representation of a cross section of a sealable laminate according to another embodiment of the invention;

FIGS. 6A-6D illustrate a peel test method;

FIG. 7 is a graph showing self-seal bond strength for laminated paperboard samples;

FIG. 8 is a photograph illustrating failed test samples showing picking for monolayer versus co-extruded samples;

FIGS. 9A-9C are graphs showing blister heat seal strength of monolayer versus co-extruded control samples;

FIG. 10 is an illustration of a device for testing blocking of coated paperboard samples;

FIG. 11A is a graph showing Coefficient of Friction data for poly to clay laminated paperboard samples; and

FIG. 11B is a graph showing Coefficient of Friction data for poly to steel laminated paperboard samples.

### DETAILED DESCRIPTION

The invention provides a sealable packaging material that is used, for example, to form a folded box, envelope, blister card or other package. In one embodiment, the material is resistant to tearing or burst damage and thus provides enhanced security for the package contents. This feature is particularly desirable in the fold-over blister packaging of pharmaceuticals where regulatory guidelines specify a certain acceptable level of child resistance. At the same time, the package must be user-friendly, fitted to frequent repeat usage and easily manipulated by the consumer.

The laminated structure of the present invention comprises one or more materials that, in combination, produce the sealable laminate that resists blocking and material transfer between layers. The laminate may be sealed to itself or to other packaging components, such as plastic blisters, by conventional methods through the use of conduction or convection heating, radiofrequency (RF), or ultrasonic energy.

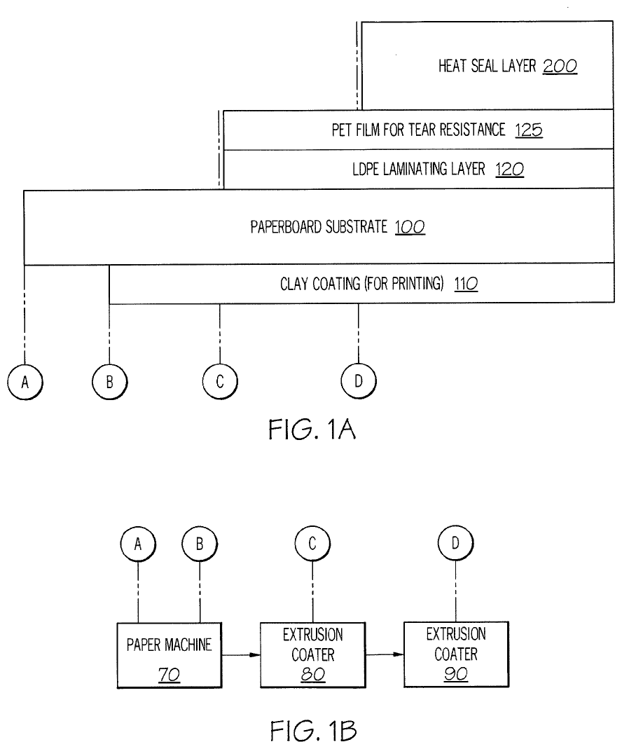

As shown in FIG. 1A, the substrate material 100 may be selected from any conventional paperboard grade, for example solid bleached sulfate (SBS) or uncoated natural kraft (UNK) or coated unbleached kraft (CUK) ranging in caliper upward from about 10 pt. to about 30 pt. An example of such a substrate is a 16-point SBS PrintKote® board manufactured by WestRock Company. The board 100 may be made on a paper machine 70 (symbolically represented in FIG. 1B) and is preferably coated on at least one side, preferably the side opposite the lamination, with a conventional coating 110 selected for compatibility with the printing method and board composition. The coated side would typically be present on the external surface of the package to allow for printing of text or graphics. The coating may be done by a coater as part of a paper machine 70, or on a separate coater. The printable coating is optional.

An adhesive layer or laminating layer 120 may be applied to an uncoated side of the paper or paperboard substrate 100. The laminating layer 120 may be a polyolefin material like low density polyethylene (LDPE).

A tear resistant layer 125 such as polymeric material may be placed in contact with the laminating layer and thus secured to the paper of paperboard substrate. The tear resistant layer imparts toughness to the laminate structure. Suitable tear resistant materials may include n-axially oriented films, e.g. MYLAR™, which is a biaxially oriented polyester, oriented nylon, e.g. DARTEK™, cross-laminated polyolefin film, e.g. VALERON™ or INTEPLUS™, which are high density polyolefins. The orientation and cross-laminated structure of these materials contribute to the tear resistant characteristic. Also, tear resistance may be attributed to the chemical nature of the tear resistant material such as extruded metallocene-catalyzed polyethylene (mPE). The laminating layer 120 and the tear resistant layer 125 may be laminated to substrate 100 applied using an extrusion coater 80 or other suitable processing method. Alternatively, the tear resistant layer 125 may be an extrusion-coated layer, such as LLDPE or mPE. In embodiments where linear low-density polyethylene (LLDPE) or mPE is used, however, it is not necessary to incorporate the laminating layer 120. Other suitable materials having a high level of tear resistance may also be used. The tear resistant layer 125 is optional, as described more fully herein.

Where a sheet material such as oriented polyester or nylon or cross-laminated is used as the tear resistant layer 125, a caliper for the tear resistant layer ranging from about 0.75 mils (approximately 16 lb/ream) or more is preferred. As used herein, ream size equals 3000 ft². For example, a suitable caliper of tear resistant material 125 may range from about 0.75 mils or more, preferably from about 1 mil to about 5 mils.

Finally, a sealable layer 200 is applied to the tear resistant layer by a process 90 such as melt extrusion. The sealable layer 200 serves as convenient means of forming packages from the laminate. When activated, the sealable layer forms an adhesive that when contacted adheres with other regions of the laminate or with other packaging components such as plastic blisters. Examples of suitable sealable material are described hereinbelow.

The process depicted in FIG. 1 is described in further detail in U.S. Pat. No. 5,091,261, the entire disclosure of which is incorporated herein by reference.

In accordance with one embodiment of the invention, a laminate structure is formed in an in-line operation by unwinding a C1S paperboard substrate 100, extruding a polymer melt of LDPE laminating layer 120 to the substrate 100 and securing a tear resistant material 125 onto the polymer melt. A layer of a sealable material 200 is extruded over the tear resistant material 125. Alternatively, both the tear resistant layer 125 and the sealable material 200 may be co-extruded. In such an application, a chemically strengthened material such as mPE, which may be extruded without compromise to its strength characteristics, can be used as the tear resistant layer 125.

The resulting flexible, laminated structure of the invention may be used in any packaging application where tear resistance is required. One of many such applications is the packaging of pharmaceuticals such as prescription medications. In one exemplary application, the laminate structure may be used to form the outer packaging of a box housing unit dose medications. In such an embodiment, the medications may be housed in individual doses on a blister card that is contained within the box interior. Packaging of other articles such as dry or semi-moist foods, cosmetics, small electronics, recording media such as CDs and tapes and various other articles are also contemplated and should be viewed as falling within the scope of this disclosure. The laminate structure of the invention may, however, also be manufactured using a lighter weight paperboard substrate or even a paper, for example, envelope grade material, to manufacture other types of containers such as envelopes or mailers. The range of potential applications is therefore quite extensive for this versatile composition.

Although tear resistance is often useful for various applications, the tear resistant layer 125 is optional and certain benefits of the laminated structure, such as improved sealable and reduced blocking are possible even without a tear resistant layer.

It should thus be understood that various elements shown in FIG. 1 may be optional. For example, the clay coating 110 (used for printing) may be optional. As discussed above, the tear resistant film 125 may be optional, and if not used, the laminating layer 120 may not be used. In certain applications, it is contemplated that a useful sealable and blocking resistant structure might be achieved using only a suitable sealable layer 200 and a paperboard substrate 100.

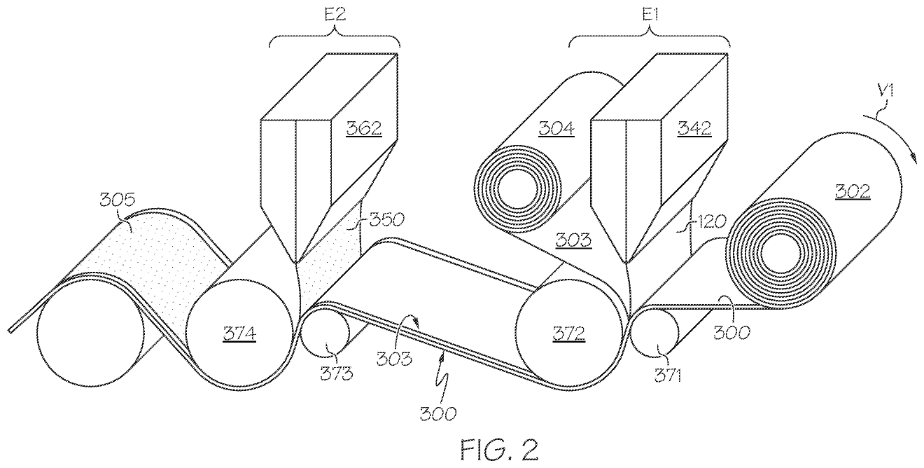

FIG. 2 shows a simplified drawing of an example process for applying a sealable layer onto a paperboard substrate. A paperboard substrate 300 is unrolled at a linear speed V1 from feed roll 302. At a first extrusion coater E1, extruder die 342 applies a curtain 120 of a laminating layer 120 such as LDPE plastic between paperboard substrate 300 and a film 303 of PET being unwound from roll 304. The paperboard 300, laminating layer 120, and PET film 303 are pressed together in a nip between pressure roll 371 and chill roll 372 which may cool the plastic before the paperboard 300/PET 303 moves to the next step of the process.

At a second extrusion coater E2, extruder die 362 applies a curtain 350 of plastic onto the PET 303 surface of the PET 303/paperboard substrate 300. The PET-coated paperboard substrate 300 and the curtain 350 are pressed together in a nip between pressure roll 373 and chill roll 374 that cools the structure before the coated paperboard 305 moves on. The process at the second extruder E2 is the general focus of most of the remaining discussion.

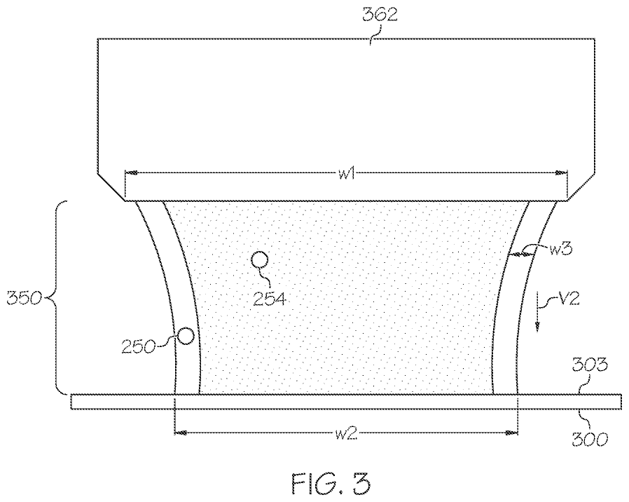

FIG. 3 shows a front view of the extrusion coating process at the second extrusion coater. On leaving the extruder die 362, the curtain 350 of plastic may have a width w1 that may depend on processing conditions including composition, temperature, and feed rate of the plastic, slot opening in the extruder die, and position of deckle rods within the die. Also dependent on these factors is the linear speed V2 of curtain 350. If the slot opening is T1 mils, the resulting film thickness T2 of the plastic on the coated paperboard 305 will be approximately T1*V2/V1 mils. Usually the paperboard speed V1 will be several times greater than the curtain speed V2, and the film thickness T2 will correspondingly be several times less than T1.

The curtain 350 as it leaves the extruder die 362 may have an initial width w1 but may “neck down” to a lesser width w2 as it is applied to the PET 303/substrate 300. The neck-down calculated as a percentage is equal to 100%*(w1−w2)/w1.

When curtain 350 is made of multiple layers of coextruded material such as in the aforementioned U.S. Published Patent Application 2018/0257349 A1, a phenomenon known as “edge encapsulation” may occur, where one of the co-extruded layers (shown as layer 250) is wider than the other layer (shown as layer 254). The edge encapsulation is measured as the distance w3 between the edges of the two layers. If the two layers are visually different then the edge encapsulation is observable and readily measured. The desired function of the narrower layer 254 is lost at the edge of the substrate 300. Any edge encapsulation results in waste product since the edges of the substrate 300 coated with the incomplete (one layer) film will be scrapped.

Another processing defect that sometimes occurs and causes waste material is “edge weave,” wherein the edges of the curtain of plastic waver sideways. With non-uniform coverage at the edges, more of the sides of the substrate need to be trimmed as waste.

Modified EMA (APPEEL™, a product of DuPont) is known to have versatile heat seal properties. However, the modified EMA faces challenges in processing due to edge weave, excessive neck-in and thermal decomposition of the plastic at the temperatures required for high temperature extrusion coating. Also, its low processing temperature does not yield good bond to substrates such as tear resistant PET film. To overcome these disadvantages, U.S. Published Patent Application 2018/0257349 A1 discloses a structure similar to that described above wherein the heat-sealable layer is a coextrusion having at least two layers, the innermost being an EMA or LDPE material and the outermost being a blend of EMA and a modified EMA. This structure provides good tear resistance and heat sealability at relatively low temperatures, but as discussed, co-extrusion is often associated with undesirable conditions such as edge encapsulation and consistent layer coat weight distribution. Additionally, in order to achieve good film adhesion between the sealable layer(s) and the tear-resistant layer, the co-extrusion process must be run at a relatively high temperature (575° F.). This can lead to excessive smoke generation.

Applicants have discovered that surprisingly improved results may be achieved by replacing the coextruded layer with a monolayer blend of the modified EMA and one or more polyethylenes selected from the group comprising homopolymers, copolymers, terpolymers, functionalized polymers, low-density polyethylene (LDPE), high-density polyethylene (HDPE), and medium-density polyethylene. The sealable monolayer is laminated directly to the tear-resistant layer or, if no tear-resistant layer is used, directly to the substrate. In one embodiment, a blend of 85% modified EMA and 15% polyethylene (by weight) is used. However, other blend ratios may also be used, such as from 5 to 95% modified EMA and 5 to 95% polyethylene or, more preferably, from 50 to 90% modified EMA and 10 to 50% polyethylene, or still more preferably, from 75 to 85% modified EMA and 15 to 25% polyethylene.

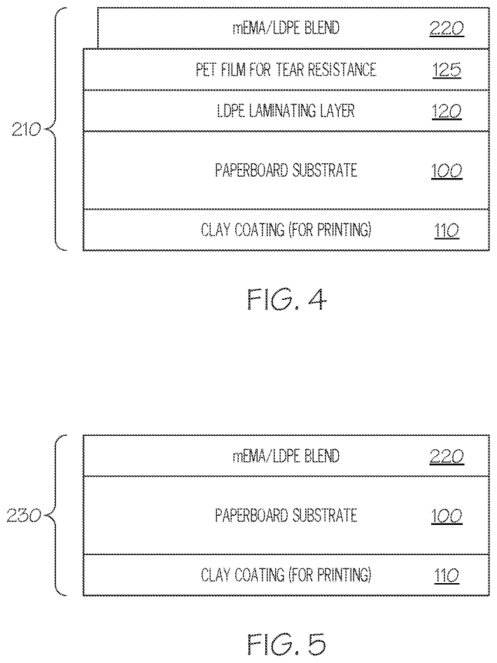

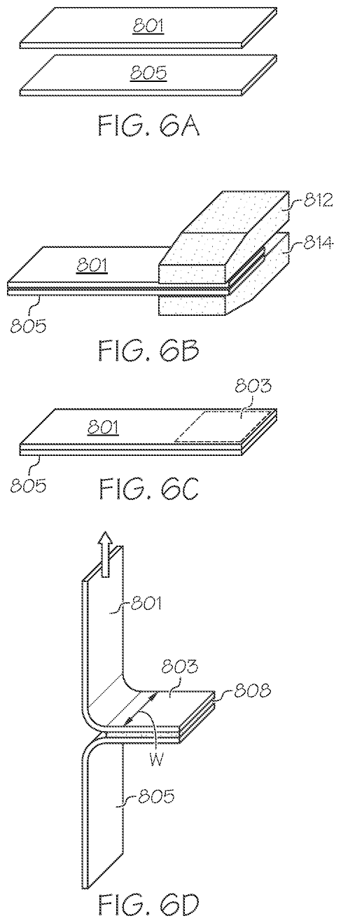

Such a laminate structure 210 is shown in FIG. 4, wherein the sealable layer 220 is laminated directly to the tear-resistant layer 125. The structure may be produced using the apparatus shown in FIG. 2. An alternate structure 230 in which no tear-resistant layer is used is shown in FIG. 5, wherein the sealable layer 220 is laminated directly to the paperboard substrate 100.

Using the monolayer structure 220 eliminates issues generally related to co-extruded structures as described above, i.e., edge encapsulation, layer drop, separation, etc. It has also been found that neck-in is reduced. Further, it was found that good adhesion of the sealable layer could be achieved at a much lower processing temperature (465° F.), thereby reducing smoke production to negligible levels. Production of the laminate structure 210 is also simplified by eliminating the need for production equipment and processes capable of co-extrusion.

The monolayer structure 220 may be extruded over a range of temperatures that result in little to no smoke production. In one aspect, the monolayer structure 220 may be applied at a melt stream temperature of 500° F. or less. In another aspect, the monolayer structure 220 may be applied at a melt stream temperature of 490° F. or less. In another aspect, the monolayer structure 220 may be applied at a melt stream temperature of 480° F. or less. In yet another aspect, the monolayer structure 220 may be applied at a melt stream temperature of 470° F. or less.

Other advantages will be apparent from the following examples and results of testing performed thereon.

### Examples

A tear-resistant substrate like that shown in FIG. 4 was provided by laminating a 144-gauge tear-resistant PET film layer (F-PAP-36 CT, a biaxially oriented PET film from Flex Films, USA) onto 18-point SBS PrintKote® paperboard. The PET layer was secured by a tie layer of LDPE extruded onto the paperboard at a coat weight of 7.0 lbs./3000 sq. ft. The LDPE used for laminating was Equistar™ NA 217 (available from Equistar Chemicals LP), having a melt index of 5.6 g/10 min, and density of 0.923 g/cc. The resulting laminated board was corona and ozone treated prior to application of a heat-seal layer.

A blend of modified EMA and LDPE (85% Dupont APPEEL™ 20D828 and 15% Westlake LDPE EC4056AA) was then prepared and extruded directly onto the tear-resistant layer at several coat weights as shown in Table 1. The monolayer was extruded at around 465° F. A control was produced using a co-extruded heat-seal layer having an inner layer of 100% modified EMA (Dupont APPEEL™ 20D828) positioned directly on the tear-resistant layer and an outer layer of a blend of modified EMA and LDPE (85% Dupont APPEEL™ 20D828 and 15% Westlake LDPE EC4056AA), applied at coat weights shown in Table 1. The co-extruded control sample was produced at a processing temperature for the heat seal layer of approximately 536° F. and a tie-layer processing temperature of approximately 558° F.

Table 1 shows details on processing parameters and observations made during the trial. Monolayer blends were extruded first followed by the co-extruded control structure. Monolayer samples were extruded at around 465° F. melt temperature, and the observed smoke level was significantly less than the co-extruded control which was processed at higher temperature. Neck-in (%) was lower for monolayer conditions than with co-extrusion, as shown in Table 1. For examples at similar 10 lbs./3000 sq. ft coat weight, the monolayer condition showed 10% neck-in vs. 14% for co-extruded control. The lower coat weight monolayer samples (8 lbs./3000 sq. ft.) exhibited a rough edge which was more pronounced on one side.

TABLE 1
Processing details of mono and co-ex conditions

| | | | Target | | | | | | | |
|---|---|---|---|---|---|---|---|---|---|---|
| | | | Coat | | | | | | | |
| | | | Weight | Corona | Line | Screw | Melt | Neck- | | |
| | | Board | lb/3000 | + | Speed | Speed | Temp | In | Smoke | Edge |
| Sample ID | Resin | Type | sq. ft | Ozone | fpm | RPM | ° F. | % | Level | Stability |
| Mono-12 lbs | APPEEL | 18 pt. | 12 | Yes | 150 | 65 | 465 | 10 | Low | Stable |
| | Blend | SBS LM | | | | | | | | |
| | (85% | Film | | | | | | | | |
| | Appeel | Laminated | | | | | | | | |
| | 20D828 + | Roll | | | | | | | | |
| | 15% | | | | | | | | | |
| | EC4056) | | | | | | | | | |
| Mono-10 lbs | APPEEL | 18 pt. | 10 | Yes | 175 | 65 | 466 | 10 | Low | Stable |
| | Blend | SBS LM | | | | | | | | |
| | (85% | Film | | | | | | | | |
| | Appeel | Laminated | | | | | | | | |
| | 20D828 + | Roll | | | | | | | | |
| | 15% | | | | | | | | | |
| | EC4056) | | | | | | | | | |
| Mono- 8 lbs | APPEEL | 20 pt. | 8 | Yes | 210 | 65 | 467 | 7.5 | Low | One side has |
| | Blend | SBS LM | | | | | | | | rough edge |
| | (85% | Film | | | | | | | | |
| | Appeel | Laminated | | | | | | | | |
| | 20D828 + | Roll | | | | | | | | |
| | 15% | | | | | | | | | |
| | EC4056) | | | | | | | | | |
| Co-Ex Control | 85% | 18 pt. | 6 | Yes | 150 | 105 | 536 | 13.75 | Medium | Stable, no |
| | Appeel | SBS LM | | | | | | | | noticeable |
| | 20D828 + | Film | | | | | | | | edge |
| | 15% | Laminated | | | | | | | | encapsulation |
| | EC4056 | Roll | | | | | | | | |
| | 100% | | 4 | | | 22 | 558 | | | |
| | APPEEL | | | | | | | | | |
| | 20D855 | | | | | | | | | |

### TESTING AND DISCUSSION OF RESULTS

### PET Adhesion Test:

This test was conducted using 3M SCOTCH™ brand OM 616 tape. The tape was laid on the sealant side of the board in cross-direction and peeled off manually. In performing such a test, it is considered as poor adhesion if the tape pulls a large area of sealant layer, and good adhesion if the sealant layer remains intact.

Tape test adhesion test observations are shown in Table 2. The tape test was performed immediately after the trial and after 24 hours of aging. Coating was also rolled manually to understand rolling resistance. No polymer lift was observed in any condition. The most common observation was that the heat-seal monolayer was breaking off more easily than the co-extruded control during the manual rolling test. This indicates that that monolayer was more brittle and had less body. This can have some benefits in sheeting and die-cutting as it may not form slivers which has been seen in co-extrusion converting.

TABLE 2
Tape Test Adhesion Test Observations

| Conditions | Tape Pull Test | Comment |
|---|---|---|
| Co-Ex Control | Pass/No poly-lift | Harder to roll but had |
| | | body to it once rolling |
| | | started |
| Mono-12 lbs. | Pass/No Poly lift | Harder to roll, breaks |
| | | little more easily on |
| | | rolling than co-ex |
| Mono-10 lbs. | Pass/No Poly lift | Harder to roll, breaks |
| | | more easily on rolling |
| | | than co-ex |
| Mono-8 lbs. | Pass/No Poly lift | Little easier to roll, |
| | | breaks most easily on |
| | | rolling. |

### Heat Seal Bond Test:

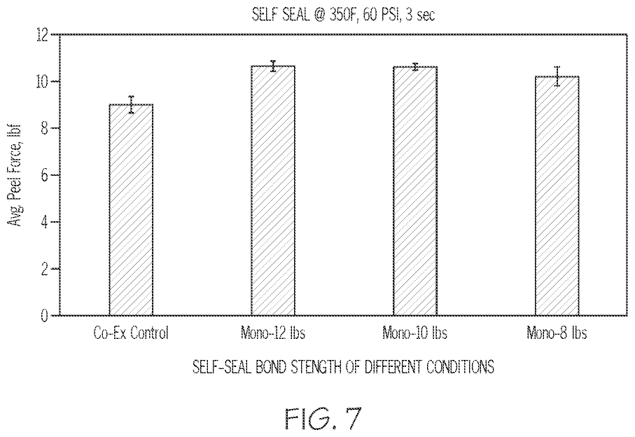

The board samples coated with heat seal material were tested for heat seal bond using a 90-degree T-peel test on an Instron 5900R machine. The method of ASTM 1876 may be referenced for this test. As depicted in FIG. 6A, a 3-inch by 1-inch sample 801 was cut from the board sample to be tested. Likewise, a 3-inch by 1-inch sample 805 was cut from 15-mil substrate used for typical blisters, namely polyvinyl chloride (PVC), amorphous polyethylene terephthalate (APET), and glycol-modified polyethylene terephthalate (PETG), as well as the same material as sample 801 (for self-seal tests). Next, as shown in FIG. 6B, a portion at one end of the samples 801, 805 was sealed together by placing between two surfaces 812, 814, with one or both surfaces being heated. A SencorpWhite Ceratek bar sealer was used in this case. Heat seal conditions were a sealing temperature of 375° F., a dwell time of 4 seconds, and a pressure or 60 psi. for the blister material, and sealing temperature of 350° F., a dwell time of 3 seconds, and a pressure or 60 psi for self-seal. As shown in FIG. 6C, a 1 sq. inch area 803 was sealed (e.g. 1-inch by 1-inch). The sealed samples were then conditioned for 24 hrs at 73° F. and 50% relative humidity before testing in a 90-degree T-Peel mode using the Instron as schematically shown in FIG. 6D. The crosshead speed Y of the Instron was 1.0 inch/min. The width W of the samples was 1 inch. As samples 801 and 805 were pulled apart, peeling the heat seal bond 808 in the area 803, the maximum load (lbf) withstood by the bond during the test was recorded and reported as peel strength. The data was reported as an average of 5 samples.

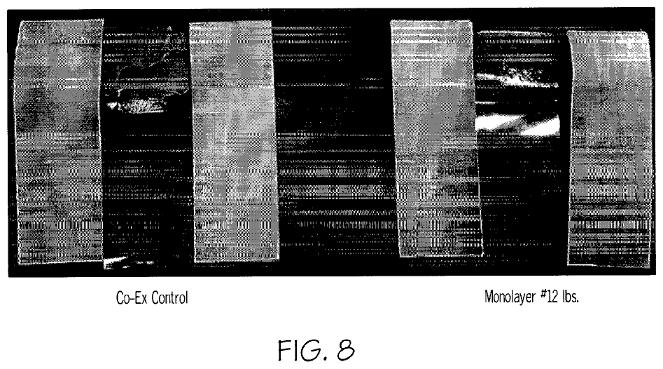

The data for self-seal peel force is shown in FIG. 7. All monolayer heat seal layer showed better peel force than co-ex. This also indicates towards a good PET film adhesion. A weaker film adhesion normally results in poor self-seal peel force as it comes off easily from PET film. All samples achieved an average peel force of 8 lbf, and more particularly at least approximately 10 lbf.

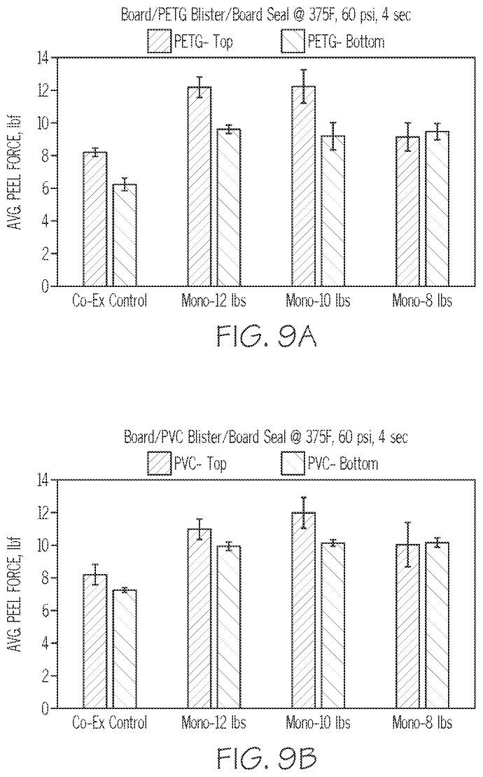

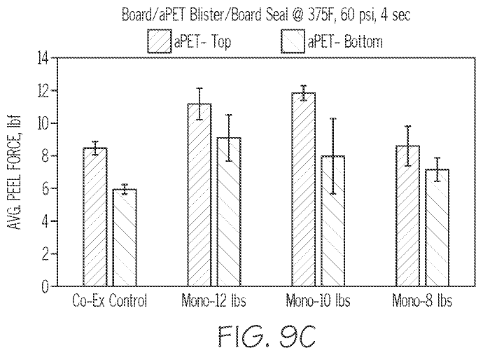

For the blister material, testing was done in a sandwich mode where the blister was placed in between two board strips and heat applied from the top. The heat-sealing condition was chosen which provided the best seal across different blisters. The monolayer samples showed strong adhesion to blisters (PETG, PVC, APET, recycled polyethylene terephthalate (RPET), and poly-chloro-trifluoroethylene (PCTFE)). All monolayer structures showed improved bond compared the co-extruded control. Failed samples also showed more picking than delamination in blister sealed samples (see FIG. 8). The monolayer bond strength against tested blisters was higher than the co-ex control structure, with an average peel force of at least 4 lbf, and more particularly at least approximately 7 lbf. (see FIGS. 9A-9C).

### Blocking Test:

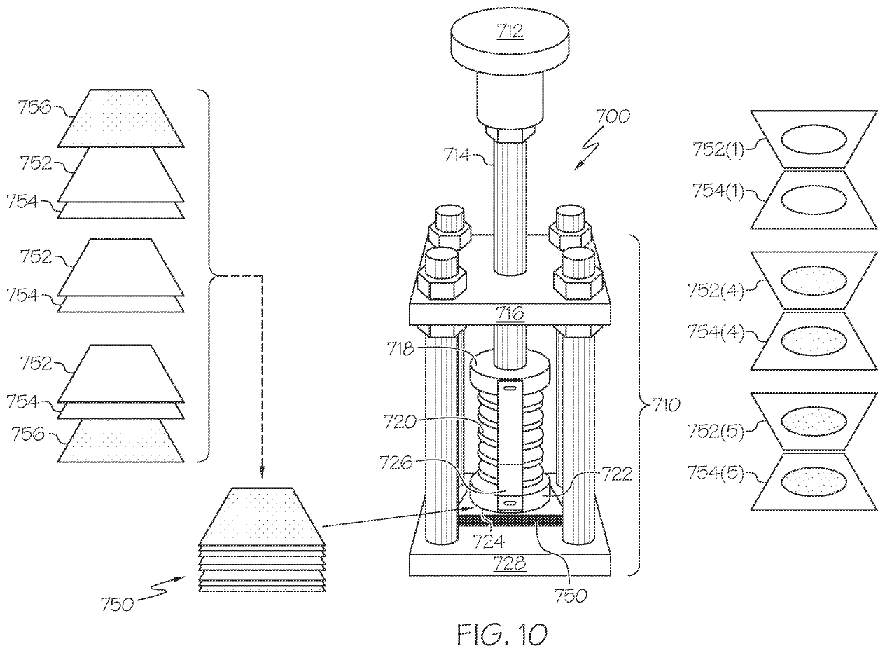

The blocking behavior of the samples was tested by evaluating the adhesion between the heat-seal side and the other side. A simplified illustration of the blocking test is shown in FIG. 10. The paperboard was cut into 2″×2″ square samples. Typically, 50 duplicates were tested for each condition, with each duplicate evaluating the blocking between a pair of samples 752, 754. (The results were averaged for each condition (e.g. the 50 values were averaged). Each pair was positioned with the heat seal side of one piece 752 contacting the opposite side of the other piece 754. The pairs were placed into a stack 750 with a spacer 756 at the top and bottom of the stack, the spacer being paperboard. The entire sample stack was placed into the test device 700 illustrated in FIG. 10.

The test device 700 includes a frame 710. An adjustment knob 712 is attached to a screw 714 which is threaded through the frame top 716. The lower end of screw 714 is attached to a plate 718 which bears upon a heavy coil spring 720. The lower end of the spring 720 bears upon a plate 722 whose lower surface 724 has an area of one square inch. A scale 726 enables the user to read the applied force (which is equal to the pressure applied to the stack of samples through the one-square-inch lower surface 724).

The stack 750 of samples is placed between lower surface 724 and the frame bottom 728. The knob 712 is tightened until the scale 726 reads the desired force of 60 lbf (60 psi applied to the samples). The entire device 700 including samples is then placed in an oven for 24 hours at 49° C. (120° F.). The device 700 is then removed from the test environment and cooled to room temperature. The pressure is then released, and the samples removed from the device.

The samples were evaluated for tackiness and blocking by separating each pair of paperboard sheets. The results (averaged as noted above) were rated according to Table 3, with a 1 rating indicating no tendency to blocking.

Blocking damage is visible as fiber tear, which if present usually occurs with fibers pulling up from the clay-coated surface of samples 754.

For example, as symbolically depicted in FIG. 10, samples 752(1)/754(1) might be representative of a “1” blocking (as stated in Table 3, no blocking, no surface change, no tack). The circular shape in the samples indicates an approximate area that was under pressure, for instance about one square inch of the overall sample. A rating of “2” would indicate no blocking, but a small surface change and small tack. A rating of “3” would indicate no blocking but a large surface change, and a large tack. Samples 752(4)/754(4) might be representative of a “4” blocking rating (small blocking, small clay transfer). Samples 752(5)/754(5) might be representative of a “5” blocking rating (blocking and fiber tear). The depictions in FIG. 10 are only meant to approximately suggest the damage to such test samples, rather than showing a realistic appearance of the samples. After evaluating each sample (pair of sheets) out of a group, the (typically) 50 values were averaged to obtain a representative blocking rating.

Blocking resistance testing was done in lab at 120° F., 60 psi, for 24 hours. All samples showed no blocking (Table 3). There was small surface change and a tack was observed. The monolayer structures did not show any adverse impact on blocking of increased coat weight of heat seal layer.

TABLE 3
Blocking test data of co-ex control and monolayer conditions

| | Block Test | |
|---|---|---|
| Conditions | Rating | Comment |
| Co-Ex Control | 2 | No Blocking, Small Surface Change, |
| | | Small Tack |
| Mono-12 lbs | 2 | No Blocking, Small Surface Change, |
| | | Small Tack |
| Mono-10 lbs. | 2 | No Blocking, Small Surface Change, |
| | | Small Tack |
| Mono-8 lbs. | 2 | No Blocking, Small Surface Change, |
| | | Small Tack |

Rating System
1 = no blocking; no surface change; no tack
2 = no blocking; small surface change; small tack
3 = no blocking; large surface change; large tack
4 = small blocking; small clay transfer
5 = blocking; fiber tear

### Coefficient of Friction Test; Sutherland Rub Test:

The coefficient of friction test was conducted to measure the sleekness of sealant layer against the clay coating (print side) and steel surface. This property is important for package convertibility. The test was conducted using a HanaTek™ friction tester per ASTM D-1894-0 standards. Both static and kinetic coefficient of friction was reported for set of 5 samples.

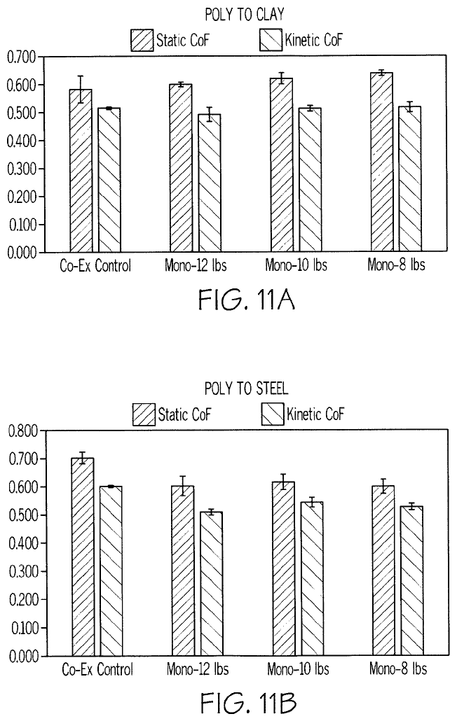

Coefficient of friction test data for heat seal layer against clay and steel surface is shown in FIGS. 11A & 11B. This data has significance in sheet feeding and sheet pulling through a printing press. The lower coefficient of friction is normally more helpful for converting. Monolayer conditions did not have significantly different coefficient of friction for poly to clay surface for monolayer vs. the co-extruded control. The poly to steel coefficient of friction was found to reduce for monolayer conditions vs. the co-extruded control.

In the Sutherland rub test, the heat seal layer was rubbed against a stainless-steel shim under 2 lbs. load. Samples were evaluated for weight loss before and after testing and for polymer delamination and scratches.

The Sutherland rub test shows the abrasion resistance of the polymer coating. The test was done by rubbing the heat seal layer against a steel surface for 100 cycles. Weight loss and physical condition of heat seal layer was evaluated before and after the test. No delamination of heat seal layer was seen in this test for all conditions. The poly abrasion weight loss after the test was also very small. The results are summarized in Table 4.

TABLE 4
Sutherland Rub Test Data

| Conditions | % weight Loss | Comment |
|---|---|---|
| Co-Ex Control | 3.1 | No Poly Delamination |
| Mono-12 lbs. | 2.4 | No Poly Delamination |
| Mono-10 lbs. | 2.4 | No Poly Delamination |
| Mono-8 lbs. | 1.3 | No Poly Delamination |

Although various aspects of the disclosed laminate structure have been shown and described, modifications may occur to those skilled in the art upon reading the specification. The present application includes such modifications and is limited only by the scope of the claims.

1. A laminate structure comprising:
a paperboard substrate having a first side and a second side opposed from the first side; and
a sealable layer forming the laminate outer surface on the second side, wherein the sealable layer comprises a blend of (by weight) from 5 to 95% of modified ethylene methyl acrylate, and 5 to 95% of one or more polyethylenes selected from the group comprising homopolymers, copolymers, terpolymers, functionalized polymers, low-density polyethylene, high-density polyethylene, and medium-density polyethylene.

2. The laminate structure of claim 1 wherein the sealable layer is a monolayer.

3. The laminate structure of claim 1 wherein the sealable layer comprises from 50 to 90% modified ethylene methyl acrylate, and 10 to 50% polyethylene.

4. The laminate structure of claim 1 wherein the sealable layer comprises from 75 to 85% modified ethylene methyl acrylate, and 15 to 25% polyethylene.

5. The laminate structure of claim 1 wherein the sealable layer comprises low-density polyethylene.

6. The laminate structure of claim 1 wherein the sealable layer is a heat-seal layer.

7. The laminate structure of claim 1 wherein the sealable layer contains no chill roll release.

8. The laminate structure of claim 1 further comprising a tear resistant layer between the paperboard substrate and the sealable layer.

9. The laminate structure of claim 8 wherein the sealable layer is applied directly to the tear resistant layer without any intervening layers.

10. The laminate structure of claim 8 further comprising a laminating layer between the tear-resistant layer and the paperboard substrate.

11. The laminate structure of claim 1 wherein the sealable layer is applied directly to the paperboard substrate without any intervening layers.

12. The laminate structure of claim 1 exhibiting no more than a small surface change and small tack after storing a stack of 50 sheets under 60 psi pressure in a 120° F. oven for 24 hours.

13. The laminate structure of claim 1 having a self-seal peel strength of at least 8 lbf, where the peel strength is measured after sealing together two pieces of laminate with a seal tool at 350° F. and 60 psi for 3 seconds, then peeling the two pieces apart by the T-peeling method for a 1 square inch sealed area pulled at a rate of 1 inch per minute.

14. The laminate structure of claim 1 having a peel strength of at least 4 lbf when sealed to a plastic blister material, where the peel is measured after sealing the laminate to the plastic sheet material with a seal tool at 375° F. and 60 psi for 4 seconds, then peeling the two pieces apart by the T-peeling method for a 1 square inch sealed area pulled at a rate of 1 inch per minute.

15. The laminate structure of claim 14 wherein the plastic blister material is selected from the group consisting of polyvinyl chloride, amorphous polyethylene terephthalate, glycol-modified polyethylene terephthalate, recycled polyethylene terephthalate, poly-chloro-trifluoroethylene, and mixtures thereof.

16. The laminate structure of claim 1 wherein the sealable layer weighs from 6 to 16 lb/3000 sq. ft.

17. The laminate structure of claim 1 wherein the paperboard substrate is one of a solid bleached sulfate or unbleached kraft board.

18. The laminate structure of claim 1 wherein the first side of the paperboard substrate comprises a print coating.

19. The laminate structure of claim 18 wherein the print coating comprises clay.

20. A method for manufacturing a laminate structure comprising:
applying onto a paperboard substrate a sealable layer that comprises a blend of (by weight) from 5 to 95% of modified ethylene methyl acrylate, and 5 to 95% of one or more polyethylenes selected from the group comprising homopolymers, copolymers, terpolymers, functionalized polymers, low-density polyethylene, high-density polyethylene, and medium-density polyethylene.

21-30. (canceled)
